(19) United States
(12) Patent Application Publication
(10) Pub. No.: US 2011/0149031 A1
(43) Pub. Date: Jun. 23, 2011

(54) STEREOSCOPIC IMAGE, MULTI-VIEW IMAGE, AND DEPTH IMAGE ACQUISITION APPARATUS AND CONTROL METHOD THEREOF

(75) Inventors: Gi Mun UM, Daejeon (KR); Gun Bang, Daejeon (KR); Won-Sik CHEONG, Daejeon (KR); Hong-Chang SHIN, Seoul (KR); Taeone KIM, Daejeon (KR); Eun Young CHANG, Daejeon (KR); Namho HUR, Daejeon (KR); Jin Woong KIM, Daejeon (KR); Soo In LEE, Daejeon (KR)

(73) Assignee: Electronics and Telecommunications Research Institute, Daejeon (KR)

(21) Appl. No.: 12/857,970

(22) Filed: Aug. 17, 2010

(30) Foreign Application Priority Data
Dec. 21, 2009 (KR) 10-2009-0128125

(51) Int. Cl. H04N 13/02; H04N 13/00

(52) U.S. Cl. 348/43; 348/47; 348/E13.074; 348/E13.001

(57) ABSTRACT

Provided is a camera apparatus, including: a camera unit including at least two cameras to acquire a stereoscopic image; a camera control unit to adjust a view angle of the at least two cameras and an interval between the at least two cameras; a depth information obtainment unit to obtain depth information from the stereoscopic image; and an intermediate image generator to generate an intermediate image based on the stereoscopic image and the depth information.

### CROSS-REFERENCE TO RELATED APPLICATION

This application claims the benefit of Korean Patent Application No. 10-2009-0128125, filed on Dec. 21, 2009, in the Korean Intellectual Property Office, the disclosure of which is incorporated herein by reference.

### BACKGROUND

1. Field of the Invention

The present invention relates to an image acquisition apparatus and method, and more particularly, to a camera apparatus that may acquire a stereoscopic image, a multi-view image, and a depth image, and a method of controlling the camera apparatus.

2. Description of the Related Art

An existing stereo camera apparatus or a multi-view camera apparatus can acquire images from two viewpoints such as a left viewpoint and a right viewpoint, or from at least three viewpoints. In general, the stereo camera apparatus can acquire a left image and a right image by installing a left camera and a right camera based on a horizontal axis or as a convergence type.

The multi-view camera apparatus may acquire an image by installing cameras for at least three viewpoints, and thus may acquire images from multiple viewpoints.

However, since rectification between cameras is not easily performed and a scale of a camera system is larger than a conventional camera system, changing a location of a camera becomes inconvenient.

### SUMMARY

An aspect of the present invention provides a camera apparatus that may acquire a stereoscopic image, a multi-view image, and a depth image by adding, to a stereo camera, a depth information generation function and an intermediate image generation function, and a method of controlling the camera apparatus.

Another aspect of the present invention also provides a camera apparatus that may combine a stereoscopic image and a multi-view image and also combine a single color image and a depth image or a multi-color image and a depth image using a depth image generation function, and a method of controlling the camera apparatus.

According to an aspect of the present invention, there is provided a camera apparatus, including: a camera unit including at least two cameras to acquire a stereoscopic image; a camera control unit to adjust a view angle of the at least two cameras and an interval between the at least two cameras; a depth information obtainment unit to obtain depth information from the stereoscopic image; and an intermediate image generator to generate an intermediate image based on the stereoscopic image and the depth information.

According to another aspect of the present invention, there is provided a camera apparatus, including: a camera unit to acquire a stereoscopic image and a depth image; a camera control unit to adjust a view angle of the camera unit and an interval of the camera unit; and an intermediate image generator to generate an intermediate image using the stereoscopic image and the depth image.

According to still another aspect of the present invention, there is provided a method of controlling a camera apparatus, including: photographing a stereo motion picture by adjusting a view angle of a stereo camera and an interval between an object and the stereo camera; storing a stereoscopic image for each frame by matching a synchronization of the stereo motion picture; performing post-processing with respect to the stereoscopic image; obtaining depth information from the post-processed stereoscopic image; and generating an intermediate image using the post-processed stereoscopic image and the depth information.

According to yet another aspect of the present invention, there is provided a method of controlling a camera apparatus, the method including: photographing a stereoscopic image and a depth image; storing a stereoscopic image for each frame by matching a synchronization between the stereoscopic image and the depth image; and generating an intermediate image using the stored stereoscopic image and the depth image.

### EFFECT

According to embodiments of the present invention, it is possible to acquire a stereoscopic image and a multi-view image together or selectively, which is different from an existing stereo camera or a multi-view camera that may acquire only one of the stereoscopic image and the multi-view image.

Also, according to embodiments of the present invention, it is possible to acquire a video image and a depth image of a corresponding viewpoint. Accordingly, it is possible to variously employ a stereoscopic image and a multi-view image for a three-dimensional (3D) TV broadcasting service and the like.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a camera apparatus according to an embodiment of the present invention;

FIG. 2 is a diagram illustrating a configuration of a camera unit according to an embodiment of the present invention;

FIG. 3 is a block diagram illustrating a configuration of a camera apparatus according to another embodiment of the present invention;

FIG. 4 is a diagram illustrating a configuration of a camera unit according to another embodiment of the present invention;

FIG. 5 is a diagram illustrating a configuration of a camera unit according to still another embodiment of the present invention;

FIG. 6 is a flowchart illustrating a method of controlling a camera apparatus according to an embodiment of the present invention; and

FIG. 7 is a flowchart illustrating a method of controlling a camera apparatus according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

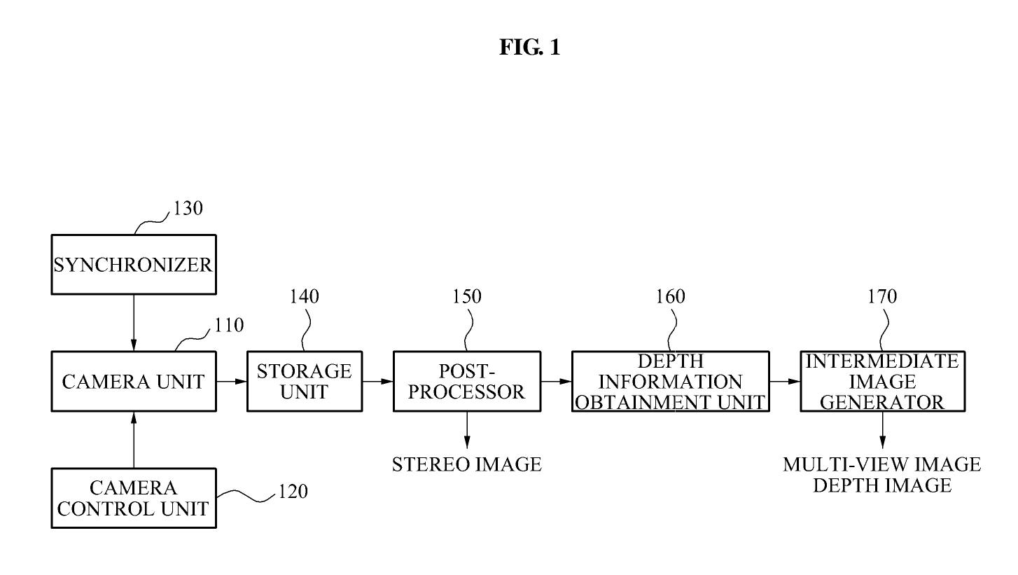

FIG. 1 is a block diagram illustrating a configuration of a camera apparatus according to an embodiment of the present invention.

Referring to FIG. 1, the camera apparatus may include a camera unit 110, a camera control unit 120, a depth information obtainment unit 160, and an intermediate image generator 170. The camera apparatus may further include a synchronizer 130, a storage unit 140, and a post-processor 150.

The camera unit 110 may include at least two cameras to acquire a stereoscopic image.

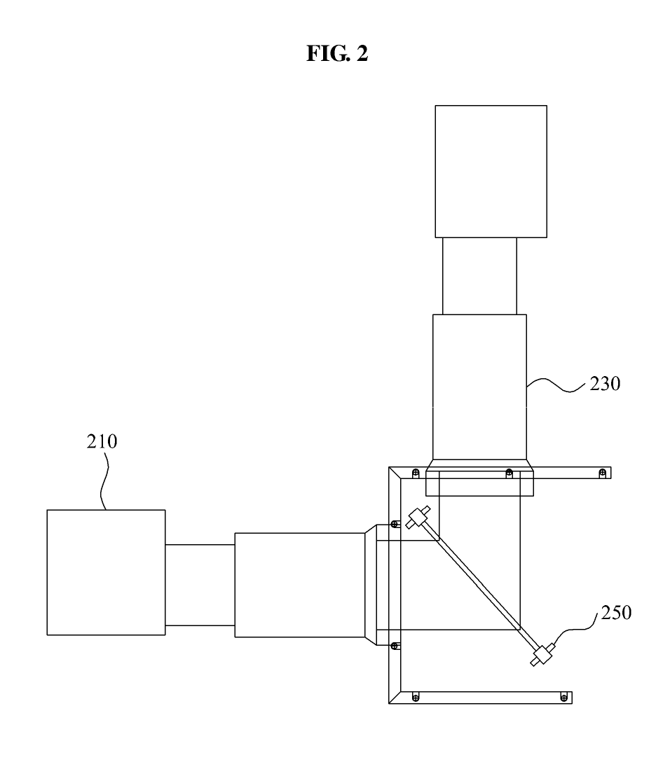

A configuration of the camera unit 110 will be further described with reference to FIG. 2.

FIG. 2 is a diagram illustrating a configuration of a camera unit according to an embodiment of the present invention.

Referring to FIG. 2, to generate a stereoscopic image, a multi-view image, and a depth image using a single camera apparatus, the camera unit may include at least two cameras, for example, cameras 210 and 230 and a beam splitter 250 to split light provided to the two cameras 210 and 230.

In this instance, to decrease an interval between the two cameras 210 and 230, the two cameras 210 and 230 may be vertically disposed with respect to each other as shown in FIG. 2. Each of the cameras 210 and 230 may acquire the stereoscopic image using light transmitted or reflected via the beam splitter 250.

According to a camera installation scheme, the camera unit 110 may be installed so that at least two cameras may be disposed to have the same height and to be in parallel.

The camera control unit 120 may acquire an optimal stereoscopic image by adjusting a view angle of the least two cameras and an interval between the at least two cameras, and by performing rectification of acquired stereoscopic images.

The synchronizer 130 may synchronize the at least two cameras so as to acquire a synchronized stereoscopic image.

The storage unit 140 may store the stereoscopic image acquired by each of the at least two stereo cameras. The storage unit 140 may also store a depth image or depth information acquired from the depth information obtainment unit 160, and an intermediate image generated by the intermediate image generator 170.

According to an embodiment, the camera unit 110 may include a depth camera. The storage unit 140 may store a depth image or depth information acquired by the depth camera, a depth image or depth information acquired according to image processing such as stereo matching and the like, an enhanced depth image or depth image acquired according to stereo matching using a depth image of the depth camera, and the like.

The post-processor 150 may correct a color of each of at least two stereoscopic images and perform rectification of the at least two stereoscopic images.

The post-processor 150 may calculate camera parameters of the at least two cameras constituting the camera unit 110. The camera parameters may be verified using the camera control unit 120. Calculated camera parameters may be used to generate the depth image or depth information.

For a camera parameter calculation, the post-processor 150 may use the stereoscopic images, a set of feature points, and basic camera information. In the case of a color correction, the post-processor 150 may correct a color of each stereoscopic image using a color correction chart.

When white balance, black balance, a color temperature, and the like do not match between multi-view images generated by the intermediate image generator 170, the post-processor 150 may match a color between images using a color correction algorithm.

The depth information obtainment unit 160 may obtain depth information from the stereoscopic image.

The depth information obtainment unit 160 may generate the depth image by obtaining depth information associated with the stereoscopic image, according to a stereo matching scheme.

The depth information obtainment unit 160 may combine depth information obtained from the depth camera with a stereo matching scheme, and thereby obtain a depth image or depth information with respect to a more reliable stereoscopic image.

Also, the depth information obtainment unit 160 may obtain depth information using a segmentation area extraction and a stereo matching scheme.

In the case of the segmentation area extraction, an object and a background within an image may be initially segmented using a characteristic that a depth difference between a front view and a background of an initial depth image of the depth camera is greater than a depth difference between objects. Next, the segmentation area extraction may be performed through segmentation of a color image for each segmented object and background area.

In this instance, the depth information obtainment unit 160 may obtain more accurate depth information, that is, depth value with respect to segmentation areas having a similar color, however, having a different depth by using the extracted segmentation areas of the object and the background for depth information extraction based on the segmentation areas.

The depth image corresponds to an image indicating a distance between an object positioned in a three-dimensional (3D) space and a camera photographing the object, based on a black-and-white unit. The depth image may be frequently used for a 3D reconfiguration scheme or a 3D warping scheme through depth information and camera parameters. The depth image may also be used to configure a realistic image in a free viewpoint TV and a 3D TV.

The intermediate image generator 170 may generate the intermediate image using the stereoscopic image and depth information.

Also, the intermediate image generator 170 may generate the intermediate image based on a number of viewpoints received from a user, an interval between the viewpoints, and a location of each of the viewpoints. Here, the intermediate image denotes another viewpoint of an image existing between two stereoscopic images. For example, when five viewpoints are received from the user, the intermediate image generator 170 may generate five viewpoint images using stereoscopic images, that is, two images and depth information.

The intermediate image generator 170 may generate the intermediate image using, for example, a depth image based rendering (DIBR) scheme and the like.

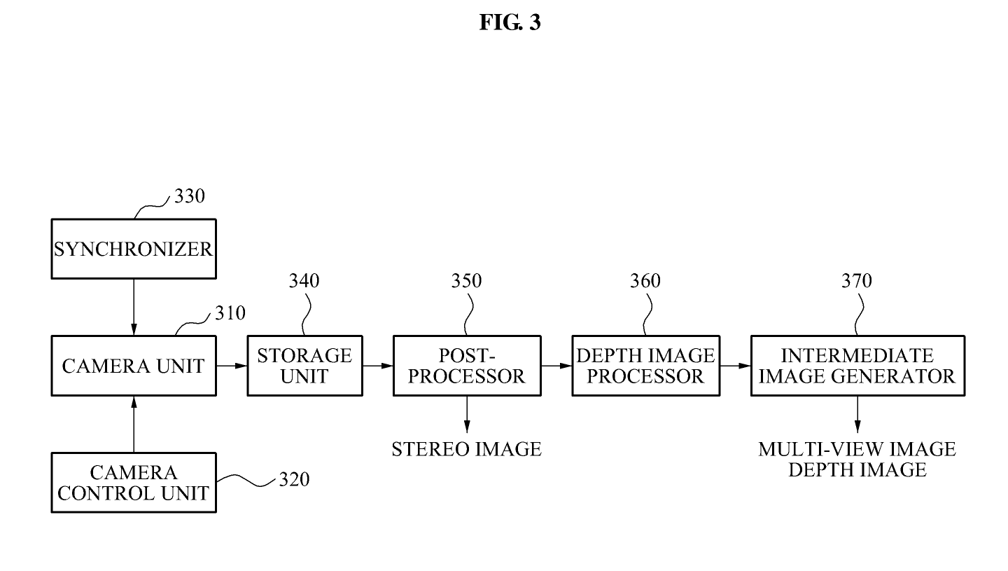

FIG. 3 is a block diagram illustrating a configuration of a camera apparatus according to another embodiment of the present invention. Referring to FIG. 3, the camera apparatus may include a camera unit 310, a camera control unit 320, and an intermediate image generator 370. The camera apparatus may further include a synchronizer 330, a storage unit 340, a post-processor 350, and a depth image processor 360.

FIG. 3 shows the camera apparatus of generating a stereoscopic image, a multi-view image, and a depth image using a stereo camera and a depth camera.

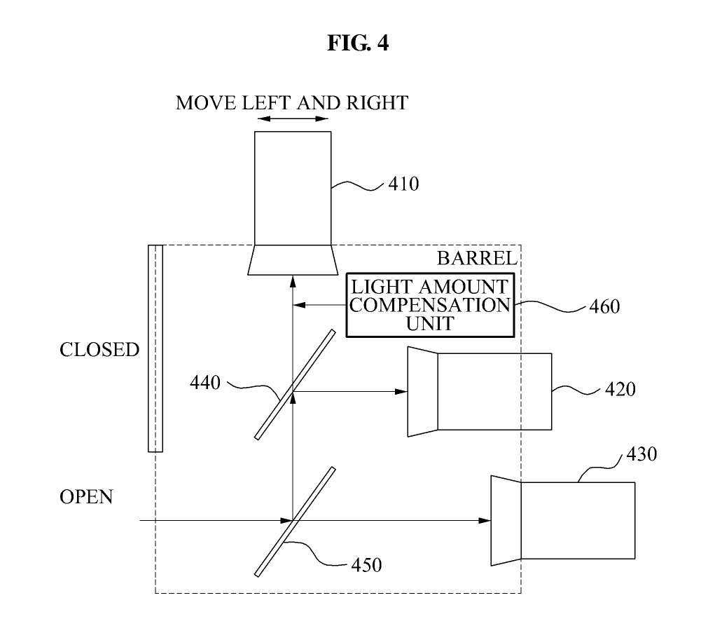

The camera unit 310 may acquire the stereoscopic image and the depth image. A configuration of the camera unit 310 will be further described with reference to FIG. 4.

FIG. 4 is a diagram illustrating a configuration of a camera unit according to another embodiment of the present invention.

Referring to FIG. 4, the camera unit may include at least two stereo cameras, for example, stereo cameras 410 and 420 for acquiring a stereoscopic image, a depth camera 430 for acquiring a depth image, and at least two beam splitters, for example, beam splitters 440 and 450 for separating light provided to the at least two stereo cameras and the depth camera.

The camera unit may further include a light amount compensation unit 460 to adjust a brightness of the stereoscopic image by compensating for an amount of light provided to the camera unit.

To generate the stereoscopic image, a multi-view image, and the depth image using a single camera apparatus, the camera apparatus according to an embodiment of the present invention may dispose a single stereo camera 420 and the depth camera 430 to be in parallel with each other in a vertical direction or a horizontal direction.

In this instance, by using two beam splitters 440 and 450, one beam splitter may be enabled to transmit or reflect only visible light and another beam splitter may be enabled to transmit or reflect only an infrared (IR) light. A pair of the stereo cameras 410 and 420 spaced apart from each other at a predetermined interval may receive the visible light via the beam splitter 440.

For example, as shown in FIG. 4, the two stereo cameras 410 and 420 may be vertically disposed with respect to each other, and may acquire a color image through the visible light transmitted or reflected via the two beam splitters 440 and 450. In this instance, the depth camera 430 may be disposed to be in parallel with the stereo camera 420 that is one of the stereo cameras 410 and 420, and may acquire the depth image through the IR ray transmitted or reflected via the beam splitter 450 that is one of the beam splitters 440 and 450.

According to an embodiment, when all of the stereo cameras 410 and 420 correspond to color cameras and are of the same type, the stereo cameras 410 and 420 may be configured as orthogonal stereo cameras that may adjust a camera interval by moving one of the cameras left or right.

Also, according to an embodiment, when the stereo camera 420 and the depth camera 430 use a color and a camera lens having the same horizontal and vertical Field Of View (FOV), an aspect ratio, or a resolution, and a charge coupled device (CCD), it is possible to configure a single-viewpoint color image and depth image acquisition camera that may acquire a color image photographing the same area and a corresponding depth image. A size of the depth image may be different from a size of the color image according to a resolution.

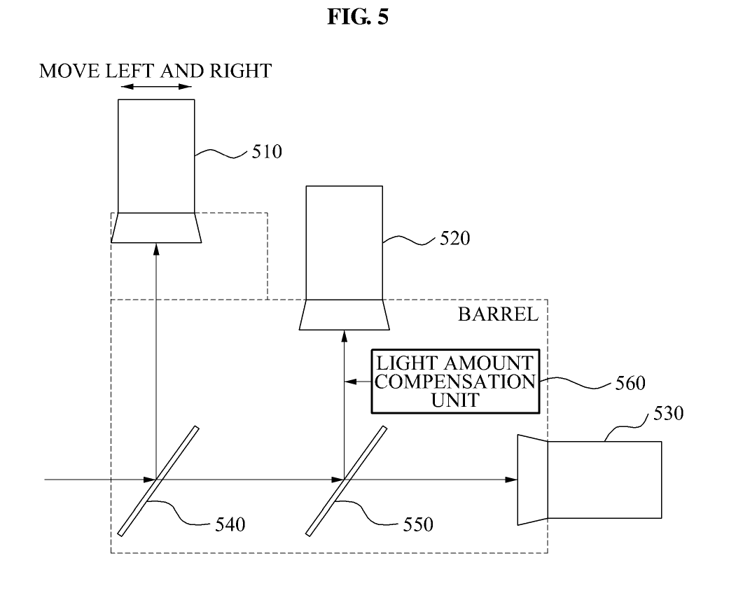

The camera unit may be configured as shown in FIG. 5. FIG. 5 is a diagram illustrating a configuration of a camera unit according to still another embodiment of the present invention.

Referring to FIG. 5, in the camera unit, at least two stereo cameras, for example, stereo cameras 510 and 520 may be disposed to be in parallel with each other. At least two beam splitters, for example, beam splitters 540 and 550 may be disposed to be in parallel with each other. The stereo cameras 510 and 520 may acquire a stereoscopic image through visible light transmitted or reflected via the corresponding beam splitters 540 and 550.

In this instance, the depth camera 530 may be vertically disposed with respect to the two stereo cameras 510 and 520, and may acquire a depth image through an IR ray transmitted via the two beam splitters 540 and 550.

Referring again to FIG. 3, the camera control unit 320 may adjust a view angle and cameras constituting the camera unit 310, that is, at least two stereo cameras and a depth camera, and an interval between cameras. Also, the camera unit 320 may align stereoscopic images by adjusting a camera alignment.

To match a synchronization between the stereoscopic image and the depth image, the synchronizer 330 may synchronize the at least two stereo cameras and the depth camera constituting the camera unit 310.

The storage unit 340 may store the stereoscopic image acquired by each of the at least two stereo cameras, and the depth image acquired by the depth camera. Also, the storage unit 340 may store the intermediate image generated by the intermediate image generator 370, and may also store the depth image processed by the depth image processor 360.

The post-processor 350 may correct a color of the stereoscopic image and perform rectification of the stereoscopic image.

The depth image processor 360 may process the depth image photographed by the depth camera. The depth image processor 360 may process a variation between two stereoscopic images or the depth image by performing 3D projection and interpolation of the depth image acquired by the depth camera, depth information enhancement (stereo matching, etc.), and the like.

Generally, although the depth image is captured by the depth camera, the depth image may mostly have a lower resolution than a color image or may be very noisy in a spatial or time domain. Accordingly, the depth image may be processed to have a higher resolution up to that of the color image and to be less noisy.

The intermediate image generator 370 may generate the intermediate image using the stereoscopic image and the depth image.

Also, the intermediate image generator 370 may generate the intermediate image based on a number of viewpoints received from a user, an interval between the viewpoints, and a location of each of the viewpoints.

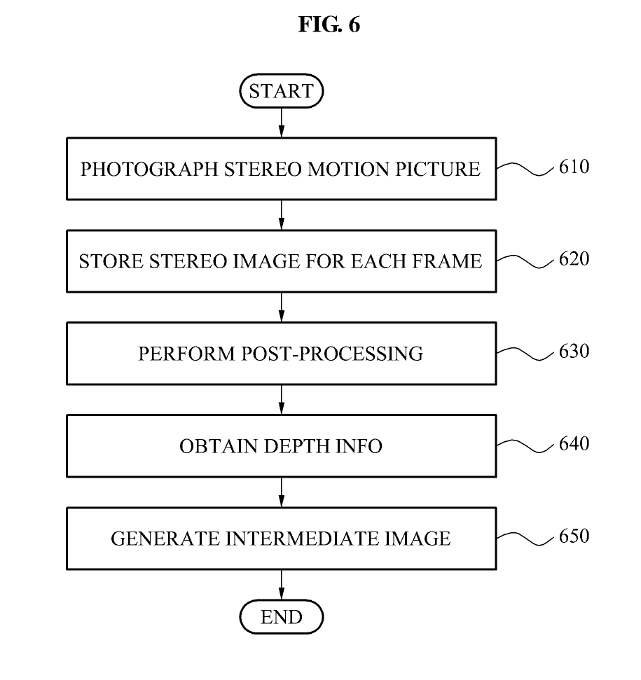

FIG. 6 is a flowchart illustrating a method of controlling a camera apparatus according to an embodiment of the present invention.

Referring to FIG. 6, the method of controlling the camera apparatus may include operation 610 of photographing a stereo motion picture, operation 620 of storing a stereoscopic image for each frame, operation 630 of performing post-processing, operation 640 of obtaining depth information, and operation 650 of generating an intermediate image.

In operation 610, a user may photograph the stereo motion picture by setting a desired main viewpoint and camera interval using a camera control unit.

In operation 620, a storage unit may store the photographed stereo motion picture as a stereo image for each frame according to synchronization of a synchronizer.

In operation 630, the stored stereoscopic image may experience post-processing such as a camera parameter calculation, a color correction, a stereoscopic image rectification, and the like, using a post-processor. In operation 640, the post-processed image and camera parameter may be transferred to a depth information obtainment unit and be used to obtain depth information associated with the stereoscopic image.

Here, the depth information may be obtained using, for example, a stereo matching scheme, and the like.

In operation 650, an intermediate image generator may generate an intermediate image of at least one viewpoint corresponding to a number of viewpoints set by the user, a generation location of each of the viewpoints, and a generation interval between the viewpoints, using post-processed left and right stereoscopic images and a corresponding depth image, a camera parameter of each viewpoint, and the like, and may store the generated intermediate image as a digital image, thereby acquiring a multi-view image.

In operation 650, in addition to a color image associated with an intermediate viewpoint, the intermediate image generator may also obtain depth image data with respect to the stereoscopic image and the multi-view image through 3D projection and interpolation, a depth image enhancement process, and the like.

According to an embodiment of the present invention, there may be provided a camera apparatus that may additionally acquire a multi-view image and a multi-view depth image by means of a multi-view camera, using a left-and-right stereoscopic image acquisition function of an existing stereo camera, a stereoscopic image post-processing function, a depth information extraction function, and an intermediate image generation function.

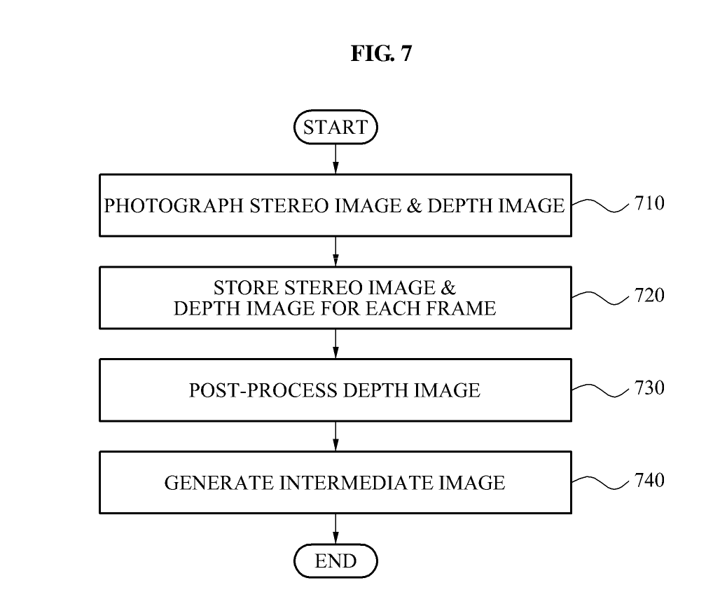

FIG. 7 is a flowchart illustrating a method of controlling a camera apparatus according to another embodiment of the present invention.

The method of controlling the camera apparatus of FIG. 7 corresponds to a method of controlling a camera apparatus including a stereo camera and a depth camera. In operation 710, a stereoscopic image and a depth image may be photographed. In operation 720, the stereoscopic image and the depth image may be stored for each frame by matching synchronization between the stereoscopic image and the depth image.

In this instance, the synchronization between the stereoscopic image and the depth image may be enabled by matching the synchronization between the stereo camera and the depth camera using a synchronizer.

Also, when acquiring the stereoscopic image, it is possible to adjust a brightness of the stereoscopic image by compensating for an amount of light provided to the stereo camera. Due to the insufficient amount of light provided to an inside of a barrel of a camera unit, the brightness of image may be different from an actual image. Accordingly, the amount of light may be adjusted to prevent the above event.

In operation 730, the depth image stored for each depth may be processed. Generally, although the depth image is captured by the depth camera, the depth image may mostly have a lower resolution than a color image or may be very noisy in a spatial or time domain. Accordingly, the depth image may be processed to have a higher resolution up to that of the color image and to be less noisy.

In operation 740, an intermediate image may be generated using the stereoscopic image and the depth image stored in a storage unit. Here, the intermediate image indicates a multi-view image generated using the stereoscopic image and the depth image. The intermediate image may be generated based on a number of viewpoints received from a user, an interval between the viewpoints, and a location of each of the viewpoints.

In regards to the camera apparatus and the method of controlling the camera apparatus described above with reference to FIG. 1 through FIG. 7, constituent elements having the like name, terms, and other parts may refer to each other.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A camera apparatus, comprising:
a camera unit comprising at least two cameras to acquire a stereoscopic image;
a camera control unit to adjust a view angle of the at least two cameras and an interval between the at least two cameras;
a depth information obtainment unit to obtain depth information from the stereoscopic image; and
an intermediate image generator to generate an intermediate image based on the stereoscopic image and the depth information.

2. The camera apparatus of claim 1, wherein:
the camera unit further comprises a beam splitter to split light provided to the at least two cameras, and
the at least two cameras are vertically disposed with respect to each other, and each of the at least two cameras acquires the stereoscopic image using the light transmitted or reflected via the beam splitter.

3. The camera apparatus of claim 1, wherein the depth information obtainment unit generates a depth image by obtaining the depth information associated with the stereoscopic image, according to a stereo matching scheme.

4. The camera apparatus of claim 1, wherein the intermediate image generator generates the intermediate image based on a number of viewpoints received from a user, an interval between the viewpoints, and a location of each of the viewpoints.

5. The camera apparatus of claim 1, further comprising:
a post-processor to correct a color of the stereoscopic image and to perform rectification of the stereoscopic image.

6. The camera apparatus of claim 1, further comprising:
a synchronizer to synchronize the at least two cameras so as to acquire a synchronized stereoscopic image.

7. A camera apparatus, comprising:
a camera unit to acquire a stereoscopic image and a depth image;
a camera control unit to adjust a view angle of the camera unit and an interval of the camera unit; and
an intermediate image generator to generate an intermediate image using the stereoscopic image and the depth image.

8. The camera apparatus of claim 7, wherein the camera unit comprises:
at least two stereo cameras to acquire the stereoscopic image;
a depth camera to acquire the depth image; and
at least two beam splitters to split light provided to the at least two stereo cameras and the depth camera.

9. The camera apparatus of claim 8, wherein:
the at least two stereo cameras are vertically disposed with respect to each other, and acquire a color image using visible light transmitted or reflected via the corresponding at least two beam splitters, and
the depth camera is disposed to be in parallel with one of the at least two stereo cameras, and acquires the depth image using an infrared ray transmitted or reflected via one of the at least two beam splitters.

10. The camera apparatus of claim 8, wherein:
the at least two stereo cameras are disposed to be in parallel with each other, and the at least two beam splitters are disposed to be in parallel with each other, and the at least two stereo cameras acquire the stereoscopic image using visible light transmitted or reflected from the corresponding at least two beam splitters, and
the depth camera is vertically disposed with respect to the at least two stereo cameras, and acquires the depth image using an infrared ray transmitted via the at least two beam splitters.

11. The camera apparatus of claim 7, wherein the intermediate image generator generates the intermediate image based on a number of viewpoints received from a user, an interval between the viewpoints, and a location of each of the viewpoints.

12. The camera apparatus of claim 7, further comprising:
a post-processor to correct a color of the stereoscopic image and to perform rectification of the stereoscopic image.

13. The camera apparatus of claim 7, further comprising:
a light amount compensation unit to adjust a brightness of the stereoscopic image by compensating for an amount of light provided to the camera unit.

14. The camera apparatus of claim 8, further comprising:
a synchronizer to synchronize the at least two stereo cameras and the depth camera so as to match a synchronization between the stereoscopic image and the depth image.

15. A method of controlling a camera apparatus, comprising:
photographing a stereo motion picture by adjusting a view angle of a stereo camera and an interval between an object and the stereo camera;
storing a stereoscopic image for each frame by matching a synchronization of the stereo motion picture;
performing post-processing with respect to the stereoscopic image;
obtaining depth information from the post-processed stereoscopic image; and
generating an intermediate image using the post-processed stereoscopic image and the depth information.

16. The method of claim 15, wherein the performing comprises correcting a color of the stereoscopic image and performing rectification of the stereoscopic image.

17. The method of claim 15, wherein the generating comprises generating the intermediate image based on a number of viewpoints received from a user, an interval between the viewpoints, and a location of each of the viewpoints.

18. A method of controlling a camera apparatus, the method comprising:
photographing a stereoscopic image and a depth image;
storing a stereoscopic image for each frame by matching a synchronization between the stereoscopic image and the depth image; and
generating an intermediate image using the stored stereoscopic image and the depth image.

19. The method of claim 18, wherein the generating comprises generating the intermediate image based on a number of viewpoints received from a user, an interval between the viewpoints, and a location of each of the viewpoints.

20. The method of claim 18, further comprising:
adjusting a brightness of the stereoscopic image by compensating for an amount of light provided to the camera apparatus.
